(19) United States
(12) Patent Application Publication
(10) Pub. No.: US 2008/0244728 A1
(43) Pub. Date: Oct. 2, 2008

(54) RELAY APPARATUS, RELAY METHOD, A COMPUTER-READABLE RECORDING MEDIUM RECORDING A RELAY PROGRAM THEREIN AND INFORMATION PROCESSING APPARATUS

(75) Inventor: Akira TERASOMA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited.

(21) Appl. No.: 12/136,911

(22) Filed: Jun. 11, 2008

Related U.S. Application Data
(63) Continuation of application No. PCT/JP2005/023069, filed on Dec. 15, 2005.

(51) Int. Cl. G06F 21/20

(52) U.S. Cl. 726/14

(57) ABSTRACT

The present relay apparatus includes: a first security information obtaining unit which obtains security information from transmission data sent from the first apparatus during specification establishing communication previously performed to encryption communication; a first registering unit which registers the obtained security information and the address of the first apparatus, as first routing information, in association with each other; a second security information obtaining unit which obtains security information from the transmission data sent from the second apparatus; and a first distributing unit which distributes the transmission data to its destination first apparatus with reference to the first routing information based on the security information obtained by the second security information obtaining unit. This construction makes it possible to perform specification establishing communication normally from multiple first apparatuses, and to correctly distribute encrypted packets to the LAN end first apparatuses.

### TECHNICAL FIELD

The present invention relates to technology for performing IPsec (IP security) packet transmission between a responder and more than one initiator by use of the IP masquerade (Internet Protocol masquerade) function.

### BACKGROUND ART

IPsec (IP security) is the technology of creating a network (IPsec tunnel) dedicated to a specific user.

In the technology, encryption and setting of authentication information are executed, so that applications and data in a LAN (Local Area Network) located a long distance place are able to be safely used on the Internet.

Firstly, negotiation of IPsec is performed between PCs (an initiator and a responder) which intend to perform communication using IPsec. This IPsec negotiation performs packet transmission using UDP (User Datagram Protocol) port No. 500 with use of a protocol called IKE (Internet Key Exchange).

FIG. 15(a) and FIG. 15(b) each are diagrams for describing processes (phases) performed in negotiation for establishing IPsec connection. FIG. 15(a) is a diagram for describing phase 1; FIG. 15(a) is a diagram for describing phase 2.

Negotiation is formed by two processes (phases 1 and 2) shown in FIG. 15(a) and FIG. 15(b). First of all, in phase 1, ISAKMP (Internet Security Association Key Management Protocol) SA (Security Association) is established between the initiator 131 and the responder 132. More specifically, the initiator 131 and the responder 132 exchange six messages therebetween: “ISAKMP SA proposal”; “ISAKMP SA selection”; “information for key creation from the initiator”; “information for key creation from the responder”; “authentication data from the initiator”; and “authentication data from the responder”, thereby establishing ISAKMP SA.

After that, in phase 2, the initiator and the responder exchange therebetween three messages: “IPsec SA proposal and information for key creation”; “IPsec SA selection and information for key creation”; and “authentication data”, thereby establishing IPsec SA for a security protocol.

After completion of these two phases, it becomes possible for the initiator 131 and the responder 132 to perform encryption communication therebetween with use of IPsec.

Then, connection between a private network such as a LAN (Local Area Network) and a global network such as a WAN (Wide Area Network) with use of a router having the above described IPsec function, makes it possible to execute encryption communication using IPsec between a PC (initiator) on the LAN end and a PC (responder) on the WAN end.

Further, recently, when connection is established between a private network and a global network, a method called NAT (Network Address Translation) is generally used for making it possible for a node that is allocated with only its local IP address to access the Internet transmissively, by means of mutually translating the private IP address and a global IP address which is able to be used in accessing the Internet.

The NAT, which performs one-to-one translation between a global IP and a private IP, has a problem of impossibility of simultaneous access of multiple clients to the Internet. Hence, the IP masquerade function is used for resolving the problem.

This IP masquerade function makes it possible for more than one client to concurrently access the Internet using a single, the same global address, by means of changing the port number of TCP (Transmission Control Protocol)/UDP.

Non-patent Document 1: “The Furukawa Electric Co., Ltd.VPNSolution:WhatisVPN?/WhatisIPsec?”, [online], [searched on Sep. 22, 2005], the Internet<URL: HYPERLINK “http://www.furukawa.co.jp/network/vpn/about_vpn/ips e/ipsec_top.html” http://www.furukawa.co.jp/network/vpn/about_vpn/ipse c/ipsec_top.html>

### DISCLOSURE OF THE INVENTION

### Issue(s) to be Solved by the Invention

However, previous routers have the following problems. They are not so congenial with IPsec and NAT. That is, since it is regulated that IKE must use UDP port No. 500 in IPsec negotiation, change of the port number in the IP masquerade or the like makes it impossible to perform normal negotiation.

FIG. 16(a) and FIG. 16(b) each are diagrams for describing packets transceived during an IPsec negotiation in a case where the IP masquerade function is used in a previous router. FIG. 16(a) is a diagram showing packets (P11 through P18) transceived among initiators (PC 131a and PC 131b), a router 201, and a responder (PC 132); FIG. 16(b) is a diagram showing the SP (Source Port), the DP (Destination Port), the SA (Source Address), and the DA (Destination Address) of each packet shown in FIG. 16(a).

In this instance, in the examples of these FIG. 16(a) and FIG. 16(b), a LAN in which two initiators (PC 131a and PC 131b) are coupled thereon is connected with a WAN in which a single responder (PC 132) is coupled thereon by way of a router 201.

Further, in the examples of these FIG. 16(a) and FIG. 16(b), it is assumed that IPsec negotiation (phases 1 and 2) with use of IKE (UDP port No. 500) has already been completed between the PC 131a (initiator) and the PC 132 (responder) with packets P11, P12, P13, and P14 shown in FIG. 16(a) so that encryption communication using IPsec is available.

Under such a condition, when the PC 131b (initiator) outputs the first packet (“ISAKMP SA proposal” packet: packet P15) of phase 1 at the time of newly beginning negotiation between the PC 131b (initiator) and the PC 132 (responder), the router 201 translates the number of the source port of the packet from 500 into an arbitrary number [“1” in the example of FIG. 16(b)] with the IP masquerade (see packet P16).

Then, when the PC 132 receives the packet, in which the number of its source port has been changed by the router 201, there is a possibility that the PC 132 is incapable of identifying this packet IKE because the port number of the received packet is not 500.

Further, provisionally, even if the PC 132 can decide the protocol of the packet to be IKE and sends back the next packet (“ISAKMP SA selection” packet; packet P17) to the PC 131b, since the transmission is performed with the source port and destination port of this packet being 500, the packet becomes the same as packet P13 which has been sent in negotiation by the PC 131a. Thus, the router 201 is incapable of distinguishing the packet, so that the packet cannot be correctly distributed to the PC 131b.

In this manner, in a case of LAN-to-WAN negotiation with NAT performed in the previous router 201, there is a possibility that only one of the initiators is capable of normally performing negotiation.

FIG. 17(a) and FIG. 17(b) each are diagrams for describing packets transceived after completion of IPsec negotiation in a case where the IP masquerade function is used in the previous router. FIG. 17(a) is a diagram showing packets (P21, P22, P23, and P26) transceived between the router 201 and the responder (PC 132); FIG. 17(b) is a diagram schematically showing the content of each packet of FIG. 17(a). In this instance, in the figures, abbreviations and reference characters the same as those already described indicate the same items, and thus their detailed descriptions are omitted.

As shown in these FIG. 17(a) and FIG. 17(b), in encrypted packets P23 and P26 transceived after completion of IPsec negotiation, the addresses and the port numbers of the PCs 131a and 131b, which are the final destinations of the packets, are encrypted.

Accordingly, even if IPsec negotiation from multiple initiators is completed at the same time, and it becomes possible that encryption communication using IPsec can be performed at the same time, the port numbers themselves of the packets are encrypted with IPsec, so that the port numbers cannot be changed and it is impossible to use the IP masquerade.

In this instance, in the previous routers, packets which have been encrypted with IPsec or the like pass therethrough without being subjected to the IP masquerade thereon by use of a technique called “IPsec pass through”, and the source addresses are replaced with the global address (192.168.20.1) of the router 201. However, in such an IPsec pass through scheme, since the port number is not changed, packets P23 and P26 in FIG. 17(a) and FIG. 17(b) are falsely regarded as the same ones by the router 201.

That is, in this case, also, the router 201 is incapable of correctly distribute packets sent from the PC 132 to the PC 131a and the PC 131b. As a result, it is merely possible to couple only one initiator to the router 201.

The present invention is proposed in view of these issues, and one object of the present invention is to make it possible to normally perform IPsec negotiation from two or more initiators, and to correctly distribute packets encrypted with IPsec to PCs (initiators) on the LAN end even after completion of negotiation.

### Means to Solve the Issue(s)

In order to accomplish the above objects according to the present invention, as a generic feature, there provided is a relay apparatus which is capable of transceiving encrypted transmission data between a first apparatus and a second apparatus, the relay apparatus comprising: a first security information obtaining unit which obtains security information from transmission data sent from the first apparatus at the time of specification establishing communication performed between the first apparatus and the second apparatus, which specification establishing communication is previously performed to encryption communication; a first registering unit which registers the security information obtained by the first security information obtaining unit and the address of the first apparatus, as first routing information, in association with each other; a second security information obtaining unit which obtains security information from the transmission data sent from the second apparatus; and a first distributing unit which distributes the transmission data to the first apparatus, which is a destination thereof, with reference to the first routing information based on the security information obtained by the second security information obtaining unit.

As a preferred feature, the relay apparatus has the IP (Internet Protocol) masquerade function and further comprises: a restraining unit which restrains the IP masquerade function at the time of the specification establishing communication; and a port number setting unit which is capable of arbitrarily setting a source port of transmission data sent from the first apparatus at the time of the specification establishing communication, and the relay apparatus sends the transmission data, to which the source port is set by the port number setting unit, to the second apparatus.

As another preferred feature, the relay apparatus further comprises: a request signal sending unit which sends a request signal requesting the first apparatus of a notification of an identification value that was used at the time of the specification establishing communication after completion of the specification establishing communication; a response signal receiving unit which receives the identification value sent from the first apparatus as a response signal thereof in response to the request signal sent from the request signal sending unit; a second registering unit which registers the identification value received by the response signal receiving unit and the address of the first apparatus, as second routing information, in association with each other; an identification value obtaining unit which obtains the identification value from the transmission data sent from the second apparatus; and a second distribution unit which distributes the transmission data to the first apparatus, which is a destination thereof, with reference to the second routing information based on the identification value obtained by the identification value obtaining unit.

As another generic feature, there provided is a relay method which is capable of transceiving encrypted transmission data between a first apparatus and a second apparatus, the method comprising: a first security information obtaining step for obtaining security information from transmission data sent from the first apparatus at the time of specification establishing communication performed between the first apparatus and the second apparatus, which specification establishing communication is previously performed to encryption communication; a first registering step for registering the security information obtained in the first security information obtaining step and the address of the first apparatus, as first routing information, in association with each other; a second security information obtaining step for obtaining security information from the transmission data sent from the second apparatus; and a first distributing step for distributing the transmission data to the first apparatus, which is a destination thereof, with reference to the first routing information based on the security information obtained in the second security information obtaining step.

As a preferred feature, the relay method further comprises: a restraining step for restraining the IP (Internet Protocol) masquerade function at the time of the specification establishing communication; and a port number setting step for arbitrarily setting a source port of transmission data sent from the first apparatus at the time of the specification establishing communication, and in the first distributing step, the transmission data, to which the source port is set in the port number setting step, is sent to the second apparatus.

As another preferred feature, the relay method further comprises: a request signal sending step for sending a request signal requesting the first apparatus of a notification of an identification value which is used at the time of the specification establishing communication after completion of the specification establishing communication; a response signal receiving step for receiving the identification value sent from the first apparatus as a response signal thereof in response to the request signal sent in the request signal sending step; a second registering step for registering the identification value received in the response signal receiving step and the address of the first apparatus, as second routing information, in association with each other; an identification value obtaining step for obtaining the identification value from the transmission data sent from the second apparatus; and a second distributing step for distributing the transmission data to the first apparatus, which is a destination thereof, with reference to the second routing information based on the identification value obtained in the identification obtaining step.

As yet another generic feature, there provided is a relay program for a computer to perform transceiving encrypted transmission data between a first apparatus and a second apparatus. The program instructs a computer to execute the following steps: a first security information obtaining step for obtaining security information from transmission data sent from the first apparatus at the time of specification establishing communication between the first apparatus and the second apparatus, which specification establishing communication is previously performed to encryption communication; a first registering step for registering the security information obtained in the first security information obtaining step and the address of the first apparatus, as first routing information, in association with each other; a second security information obtaining step for obtaining security information from the transmission data sent from the second apparatus; and a first distributing step for distributing the transmission data to the first apparatus, which is a destination thereof, with reference to the first routing information based on the security information obtained in the second security information obtaining step.

As a preferred feature, the relay program instructs a computer to execute the following steps: a restraining step for restraining an IP (Internet Protocol) masquerade function at the time of the specification establishing communication; and a port number setting step for arbitrarily setting a source port for transmission data sent from the first apparatus at the time of the specification establishing communication. In the first distributing step, the transmission data, to which the source port is set in the port number setting step, is sent to the second apparatus.

As another preferred feature, the relay program instructs a computer to execute the following steps: a request signal sending step for sending a request signal requesting the first apparatus of a notification of an identification value which is used at the time of the specification establishing communication after completion of the specification establishing communication; a response signal receiving step for receiving the identification value sent from the first apparatus as a response signal thereof in response to the request signal sent in the request signal sending step; a second registering step for registering the identification value received in the response signal receiving step and the address of the first apparatus, as second routing information, in association with each other; an identification value obtaining step for obtaining the identification value for the transmission data sent from the second apparatus; and a second distributing step for distributing the transmission data to the first apparatus, which is a destination thereof, with reference to the second routing information based on the identification value obtained in the identification value obtaining step.

As still another generic feature, there provided is a computer-readable recording medium which records the above described relay program therein.

As a further generic feature, there provided is an information processing apparatus which transceives transmission data with another information processing apparatus by way of a relay apparatus, the apparatus comprising: a request signal receiving unit which receives a request signal transmitted from the relay apparatus, after completion of specification establishing communication that is performed with the another information processing apparatus previously to the specification establishment communication; and a response signal sending unit which sends an identification value which is used at the time of the specification communication, as a response signal thereof, to the relay apparatus when the request signal receiving unit receives the request signal.

### EFFECTS OF THE INVENTION

According to the present invention, at least any one of the following effects and benefits are obtained.

(1) It is possible to distribute transmission data with high reliability during specification establishing communication which is previously executed to encryption communication that is performed between the first apparatus and the second apparatus.

(2) It is possible to perform encryption communication, correctly distributing encrypted transmission data, even after completion of specification establishing communication.

### BRIEF DESCRIPTION OF THE DRAWINGS

FIG. 1 is a diagram schematically illustrating a construction of a relay system having a router (relay apparatus) according to one preferred embodiment of the present invention;

FIG. 2 is a diagram schematically illustrating a hardware construction of the router according to one preferred embodiment of the present invention;

FIG. 3 is a diagram showing an example of a routing table for use when IPsec is invalid in the router according to one preferred embodiment of the present invention;

FIG. 4 is an example of a first routing table in the router according to one preferred embodiment of the present invention;

FIG. 5 is a diagram illustrating an example of a request packet used in the router according to one preferred embodiment of the present invention;

FIG. 6 is a diagram illustrating an example of a response packet used in the router according to one preferred embodiment of the present invention;

FIG. 7 is a diagram showing an example of a second routing table in the router according to one preferred embodiment of the present invention;

FIG. 8 is a diagram showing a part of a packet sent from an initiator to a responder in phase 2 of IPsec negotiation;

FIG. 9 is a diagram showing a part of a packet sent from the responder to the initiator in phase 2 of IPsec negotiation;

FIG. 10 is a diagram showing a construction example of a packet sent from the initiator to the responder after completion of IPsec negotiation;

FIG. 11 is a diagram showing a construction example of a packet transmitted from the responder to the initiator after completion of IPsec negotiation;

FIG. 12 is a diagram showing an example of SAD in a responder coupled to the router according to one preferred embodiment of the present invention;

FIG. 13 is a flowchart for describing processing performed during IPsec negotiation in the router according to one preferred embodiment of the present invention;

FIG. 14 is a flowchart for describing processing performed after completion of IPsec negotiation in the router according to one preferred embodiment of the present invention;

FIG. 15(a) and FIG. 15(b) each are diagrams for describing processes performed in negotiation for establishing IPsec connection;

FIG. 16(a) and FIG. 16(b) each are diagrams for describing packets transceived during an IPsec negotiation in a case where the IP masquerade function is used in a previous router; and

FIG. 17(a) and FIG. 17(b) each are diagrams for describing packets transceived after completion of IPsec negotiation in a case where the IP masquerade function is used in a previous router.

### DESCRIPTION OF REFERENCE CHARACTERS

10 . . . router (relay apparatus)
11 . . . LAN end communication unit
12 . . . initiator cookie obtaining unit (first initiator cookie obtaining unit, second initiator cookie obtaining unit, first security information obtaining unit, and second security information obtaining unit)
13 . . . first registering unit
14 . . . first routing table (first routing information)
15 . . . first distributing unit
16 . . . third routing table
17 . . . WAN end communication unit
18 . . . restraining unit
19 . . . port number setting unit
20 . . . request packet sending unit (request signal sending unit)
21 . . . response packet receiving unit (response signal sending unit)
22 . . . second registering unit
23 . . . second distributing unit
24 . . . SPI value obtaining unit (identification value obtaining unit)
25 . . . second routing table (second routing information)
31, 31a, and 31b . . . PC (initiator and first apparatus)
32 . . . PC (a responder and a second apparatus)
40 . . . CPU
41 . . . memory chip
42 and 45 . . . PHY chip
43 . . . WAN end MAC
44 . . . LAN end MAC

### BEST MODE FOR CARRYING OUT THE INVENTION

Embodiments of the present invention will now be described with reference to the relevant accompanying drawings.

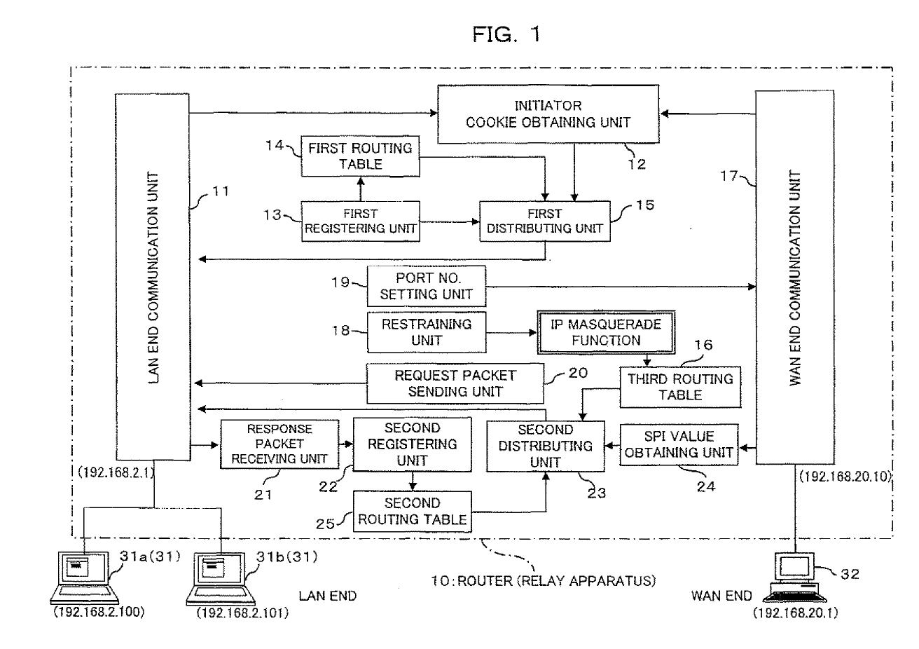

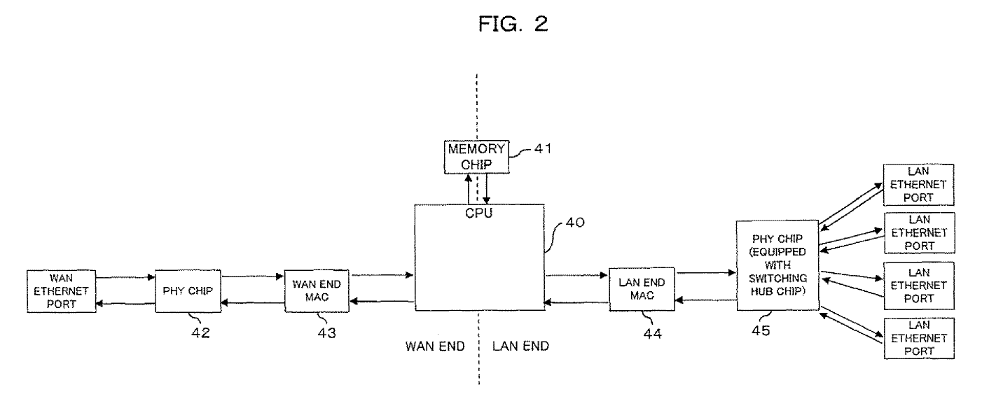

FIG. 1 is a diagram schematically illustrating a construction of a relay system having a router (relay apparatus) according to one preferred embodiment; FIG. 2 is a diagram schematically illustrating a construction of a hardware construction of the construction of the router according to one preferred embodiment.

A router (relay apparatus) 10 is a relay apparatus which couples networks in such a manner that the networks are communicable therebetween and also perform relay processing of packets these between. According to the present embodiment, the router 10 performs relay processing of packets (transmission data) between a private network (Local Area Network: LAN) and a global network (Wide Area Network: WAN). The router 10 relays (transfers and transceives) packets between one or more (two in the present embodiment) PCs (personal Computers) 31a and 31b on the LAN end and one or more (one in the present embodiment) PCs 32 on the WAN end.

In this instance, according to the present embodiment, as shown in FIG. 1, it is given that the address (the private address on the LAN) of the PC 31a is 192.168.2.100; the address of the PC 31a is 192.168.2.101; the LAN end address (private address) of the router 10 is 192.168.2.1; the address (global address) of the router 10 is 192.168.20.10; the address of the PC 32 (the global address on the WAN) is 192.168.20.1.

Further, the present router 10 has the IP masquerade function, and it is possible for multiple PCs 31a and 31b on the LAN end to simultaneously access the Internet using a single global address, by means of changing the port number of TCP/UDP (Transmission Control Protocol/User Datagram Protocol).

Furthermore, the present router 10 has the IPsec (IP Security) communication (encryption communication) function, which function makes it possible to add functions of encryption of IP packets (transmission data) and authentication, so that manipulation of packets and wire tapping can be prevented. In the example shown in FIG. 1, the router 10 makes Ipsec communication between the PCs 31a and 31b on the LAN end and the PC 32 on the WAN end possoble. In the present embodiment, a description will be made of a case in which IPsec communication is requested from the PCs 31a and 31b (initiators, first apparatuses) to the PC 32 (a responder, a second apparatus).

Hereinafter, in the present embodiment, the PC 31a and the PC 31b will be sometimes called the initiator 31a and the initiator 31b, respectively. Further, as the reference character indicating PCs (initiators), the reference characters of 31a and 31b are used when it is necessary to specify a single one of the multiple PCs (initiators), and the reference character 31 will be used for indicating an arbitrary PC (initiator).

In addition, the present router 10 is capable of performing communication without using an IPsec function as well as activating the above described Ipset function (a case of IPsec being invalid; a normal case), and such setting of valid/invalid of the IPsec function can be arbitrarily performed by, for example, the users of the PCs 31 and 32.

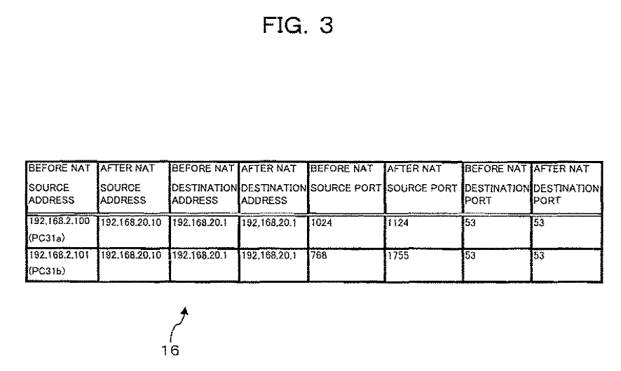

FIG. 3 is a diagram showing an example of a third routing table 16 for use when IPsec is invalid in the router 10 according to one preferred embodiment of the present invention, and shows an example of information relating to packets sent from the PCs 31a and 31b to the PC 32. As shown in this FIG. 3, in a case of IPsec being invalid, the IP masquerade function of the present router 10 changes the values of the source port and the destination port of packets into arbitrary values (1024, 1124, 768, 17555, and 53, for example), and the second distributing unit 23 (will be detailed below) distributes the packets with reference to the third routing table 16, thereby sending the packets to the correct destinations.

As shown in FIG. 2, the present router 10 includes a CPU 40, a memory chip 41, PHY chips 42 and 45, a WAN end MAC (WAN MAC) 43, and a LAN end MAC (LAN MAC) 44.

The memory chip 41 stores a first routing table 14 (see FIG. 1) and a second routing table 25 (see FIG. 1) which will be described below, as well as programs for operating the CPU (Central Processing Unit) 40 and data.

The CPU 40 executes various kinds of controlling and processing performed in the router 10. That is, the CPU 40 executes programs stored in inner storage devices such as a memory chip 41 and a non-illustrated RAM (Random Access Memory) and ROM (Read Only Memory), thereby functioning as an initiator cookie obtaining unit 12, a first registering unit 13, a first distributing unit 15, a restraining unit 18, a port number setting unit 19, a request packet sending unit 20, a response packet receiving unit 21, a second registering unit 22, a second distributing unit 23, and an SPI value obtaining unit 24.

In this instance, programs for realizing functions of such an initiator cookie obtaining unit 12, a first registering unit 13, a first distributing unit 15, a restraining unit 18, a port number setting unit 19, a request packet sending unit 20, a response packet receiving unit 21, a second registering unit 22, a second distributing unit 23, and an SPI value obtaining unit 24, can be recorded in a computer-readable recording medium such as a flexible disc, a CD (a CD-ROM, a CD-R, a CD-RW, etc.), a DVD (a DVD-ROM, a DVD-RAM, a DVD-R, a DVD+R, a DVD-RW, a DVD+RW, etc.), a magnetic disc, an optical disc, and a magneto-optical disc.

In this instance, according to the present embodiment, a “computer” is defined as a concept including hardware and an operating system, and it means hardware operating under control of an operating system. Further, in cases where application programs are capable of operating hardware by themselves without the necessity of an operating system, the hardware itself is equivalent to a computer. The hardware includes at least a micro processor such as a CPU and a means for reading computer programs stored in recording media. In the present embodiment, the router 10 has a function as a computer.

Further, as recording media used in the present embodiment, not only the above-mentioned flexible disc, CD, DVD, magnetic disc, optical disc, and magneto-optical disc, but also various types of other computer-readable media, such as an IC card, a ROM cartridge, a magnetic tape, a punch card, an internal storage device (a memory such as a RAM and a ROM), an external storage device, and printed matter with any codes such as barcodes printed thereon, are available.

The PHY chips 42 and 45 control physical connection and transmission in networks. The PHY chip 42 performs physical connection and transmission between the router 10 and the WAN Ethernet (a registered trademark), and the PHY chip 45 performs physical connection and transmission between the router 10 and the LAN Ethernet. Further, in the present embodiment, the PHY chip 45 has a switching hub chip built-in and has a function also as a switching hub.

The WAN MAC (Media Access Control) 43 performs media access control between the router 10 and a WAN. For example, it executes error detection or the like in packet transceiving. The LAN MAC 44 performs media access control between the router 10 and communication equipment on the LAN end. For example, it executes error detection or the like in packet transceiving.

Further, the router 10, as shown in FIG. 1, includes a LAN communication unit 11, a WAN communication unit 17, an initiator cookie obtaining unit (a first initiator cookie obtaining unit and a second initiator cookie obtaining unit) 12, a first registering unit 13, a first routing table 14, a first distributing unit 15, a restraining unit 18, a port number setting unit 19, a request packet sending unit 20, a response packet receiving unit 21, a second registering unit 22, a second distributing unit 23, an SPI value obtaining unit 24, and a second routing table 25.

The LAN communication unit 11 performs packet communication with the PCs 31a and 31b or the like on the LAN end, and is realized by the PHY chip 45, the LAN MAC 44, or the like in FIG. 2. The WAN communication unit 17 performs packet communication with the PC 32 or the like on the WAN end, and is realized by the PHY chip 42, the WAN MAC 43, or the like in FIG. 2.

The restraining unit 18 restrains the IP masquerade function in the above described router 10 during IPsec negotiation (specification establishing communication previously performed to encryption communication). More specifically, the restraining unit 18 restrains values of a source port and a destination port of packets from being changed into arbitrary values.

The port number setting unit 19 arbitrarily sets the source port of packets. During IPsec negotiation, the port number setting unit 19 sets the source port of packets for negotiation sent from the initiators 31a and 31b, following the IKE standard. The present embodiment sets the source port to 500 of a UDP (User Datagram Protocol) That is, the port number setting unit 19 changes the source port of packets, changes of whose source port value and destination port value (IP masquerade function) are restrained by the restraining unit 18, into 500.

The initiator cookie obtaining unit (a first initiator cookie obtaining unit, a second initiator cookie obtaining unit, a first security information obtaining unit, and a second security information obtaining unit) 12 obtain/extract an initiator cookie (security information) from each packet sent from the initiator 31 and the responder 32.

The initiator cookie is an arbitrary value created by the initiator 31 at the time of beginning of negotiation, and a 64-bit random number, for example, is used and it acts as an element creating an IPsec encryption key. In this instance, generally speaking, a common initiator cookie is used in all the packets in process phases 1 and 2 of IPsec negotiation

Then, the initiator cookie obtaining unit 12 obtains an initiator cookie which is created by the initiator 31 from the first packet (“ISAKMP SA proposal” packet) in phase 1 of IKE (Internet Key Exchange) sent from the initiator 31 during IPsec negotiation.

For example, the initiator cookie obtaining unit 12 recognizes an “ISAKMP SA proposal” packet in phase 1 of IPsec negotiation and extracts a specific portion of this packet, thereby obtaining its initiator cookie.

Further, the initiator cookie obtaining unit (a second initiator cookie obtaining unit and a second security information obtaining unit) 12 obtains the initiator cookie of packets sent from the responder 32 in the process of Ipsec negotiation. It extracts a specific portion of a packet sent from the responder 32, thereby obtaining its initiator cookie.

The first registering unit 13 stores (registers) the initiator cookie obtained by the initiator cookie obtaining unit 12, the address of the initiator 31 which has sent the packet, and the address of the responder 32, in association with each other, in the memory chip 31 in the form of a first routing table 14.

Concretely, the first registering unit 13 refers to the first routing table 14 based on the initiator cookie obtained from a packet by the initiator cookie obtaining unit 12 and the source address of the packet, to check whether or not these initiator cookie and source address are registered (stored) in the first routing table 14. If they are not registered, the first registering unit 13 regards the packet as the first packet (“ISAKMP SA proposal” packet) of phase 1 during IPsec negotiation, and adds (registers) these initiator cookie, a pre-NAT (Network Address Translation) source address, a post-NAT destination address, a pre-NAT source port, a post-NAT source port, a pre-NAT destination port, and a post-NAT destination port, in association with each other, to the first routing table 14.

In this instance, the present router 10 has an NAT (Network Address Translation) function of mutually translating a private IP address and a global IP address, which can be used for access to the Internet. This NAT function generates the post-NAT destination address, the post-NAT source port, and the post-NAT destination port. Further, such an NAT function can be realized by using various kinds of already known techniques.

The first routing table (first routing information) 14 holds initiator cookies obtained by the first initiator cookie obtaining unit 12 and the addresses of the initiators 31, of packets transmitted during IPsec negotiation, in association with each other.

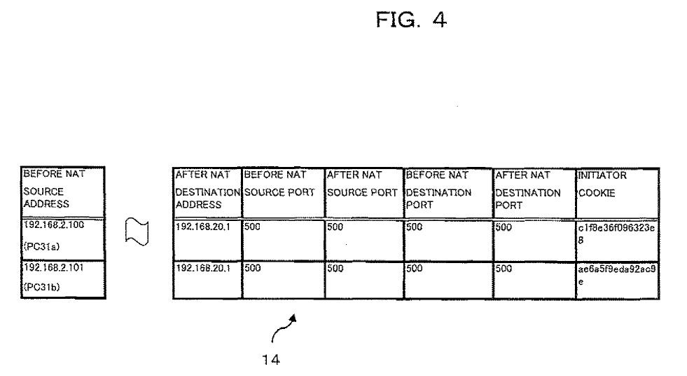

FIG. 4 is a diagram showing an example of a first routing table 14 in the router 10 according to one preferred embodiment of the present invention. As described above, the first routing table 14 shown in FIG. 4 is constructed by registering a pre-NAT source address, a post-NAT destination address, a pre-NAT source port, a post-NAT source port, a pre-NAT destination port, a post-NAT destination port, and an initiator cookie in association with each other.

Further, in the first routing table 14, an initiator cookie obtained by the initiator cookie obtaining unit 12 is associated with the address of the initiator 31 which has created the initiator cookie and the address of the responder 32, so that it is possible to support a case in which more than one responder 32 is present.

In this instance, the first routing table 14 of FIG. 4 shows information about each packet, which is sent from the PCs 31a and 31b to the responder 32 and whose source port has been changed into 500 by the port number setting unit 19 after change of the values of the source port and the destination port is restrained (the IP masquerade function) by the restraining unit 18.

In addition, this first routing table 14 is stored in, for example, a storage device such as a memory chip 41, a non-illustrated RAM and ROM and a hard disc.

The first distributing unit 15 refers to the first routing table 14 based on an initiator cookie obtained by the first initiator cookie obtaining unit 12, and distributes the packet to its destination initiator 31.

Concretely, the first distributing unit 15 refers to the first routing table 14, with respect to a packet sent from the responder 32, based on an initiator cookie obtained by the first initiator cookie obtaining unit 12, and obtains the address (source address) of the initiator 31 corresponding to the initiator cookie, and performs distribution in such a manner that the packet is sent to the initiator 31, and makes the LAN communication unit 11 send the packet to the address of the distributed initiator 31.

That is, in the present router 10, an initiator cookie acts roles similar to those of the port number in the IP masquerade during IPsec negotiation. By means of using this initiator cookie, it becomes possible to correctly distribute a packet, whose source port and destination port sent back from the responder 32 to the initiator 31 are 500, to its destination initiator 31.

The request packet sending unit (request signal sending unit) 20 sends a request packet (request signal) requesting a notification of the SPI (Security Parameter Index) value (identification value) which was used during IPsec negotiation to the initiator 31 after completion of the IPsec negotiation performed between the initiator 31 and the responder 32.

The initiator 31 (PC 31a and PC 31b) which received this request packet sends back a “response packet (response signal)” storing the SPI value therein.

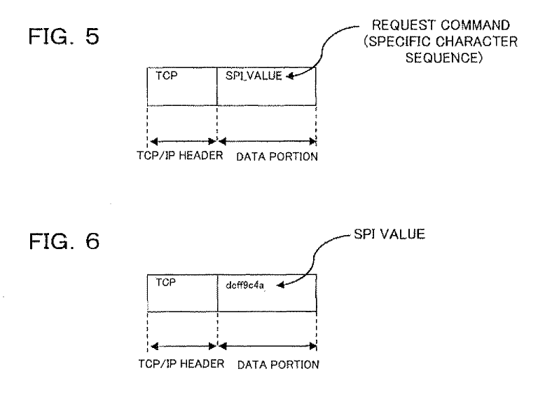

FIG. 5 is a diagram showing an example of a request packet used in the router 10 according to one preferred embodiment of the present invention; FIG. 6 is a diagram showing an example of a response packet used in the router 10 according to one preferred embodiment of the present invention.

The request packet has a specific character sequence and information (commands, or the like) for requesting the initiator 31 of a notification of the SPI value which was used during IPsec negotiation. In the example of FIG. 5, the request packet has a TCP/IP header and a data portion, and the data portion stores a command “SPI_value” requesting transmission of an SPI value.

On the other hand, the initiator 31 is stipulated (set) beforehand that when it detects a command “SPI_value” in a data portion of a received packet, it sends a response packet as shown in FIG. 6 to the router 10.

The response packet is sent from each initiator 31 as a response to a request packet sent from the request packet sending unit 20. The initiator (response packet sending unit) 31 sends a response packet (see FIG. 6) containing the SPI value (stored by the initiators 31 in an “information packet for IPsec SA proposal and key generation”) which was used during IPsec negotiation.

In this instance, in the example of FIG. 6, the response packet has a TCP/IP header and a data portion, and the data portion stores a 32-bit SPI value (“deff9c4a” in the example of FIG. 6).

The response packet receiving unit (response signal receiving unit) 21 receives the SPI value which is sent from the initiator 31 as a response packet in response to the request packet sent from the request packet sending unit 20, and extracts the SPI value from the data portion of the response packet sent from the initiator 31, and then passes this SPI value to the second registering unit 22.

The second registering unit 22 registers the SPI value received by the response packet receiving unit 21, the address of the initiator 31 which sent the response packet, and the address of the responder 32, in association with each other, as a second routing table (second routing information) 25. According to the present embodiment, the second registering unit 22 registers a pre-NAT source address, a post-NAT source address, a pre-NAT destination address, a post-NAT destination address, and an SPI value, in association with each other, as a second routing table 25.

The second routing table 25 holds, with respect to a packet transmitted after completion of IPsec negotiation, an SPI value obtained by the response packet receiving unit 21 and the address of the initiator 31 which sent the response packet in association with each other

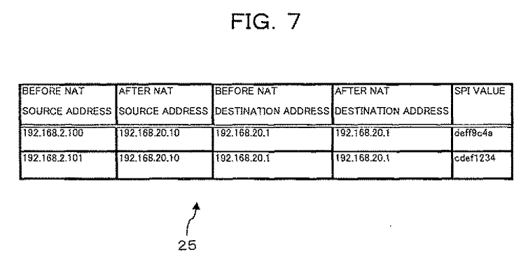

FIG. 7 is a diagram showing an example of a second routing table 25 in the router 10 according to one preferred embodiment of the present invention. As described above, the second routing table 25 of this FIG. 7 is constructed by registering a pre-NAT source address, a post-NAT source address, a pre-NAT destination address, a post-NAT destination address, and an SPI value, in association with each other.

In addition, the second routing table 25 is capable of supporting a case in which more than one responder 32 is present, by means of associating an SPI value obtained by the response packet receiving unit 21, the address of the initiator 31 which sent the response packet, and the address of each responder 32 with each other.

Further, similar to the above-mentioned first routing table 14, this second routing table 25 is stored in a storage device such as a memory chip 41, a non-illustrated RAM and ROM, and a hard disc.

In this instance, the second routing table 25 of FIG. 7 shows information about each packet sent from each of the PC 31a and the PC 31b to the responder 32.

The SPI value obtaining unit (identification value obtaining unit) 24 obtains an SPI value from a packet sent from the responder 32 in the encryption communication performed after completion of IPsec negotiation. Similar to the above described initiator cookie obtaining unit 12, the SPI value obtaining unit 24 obtains the SPI value by extracting a specific portion of the packet.

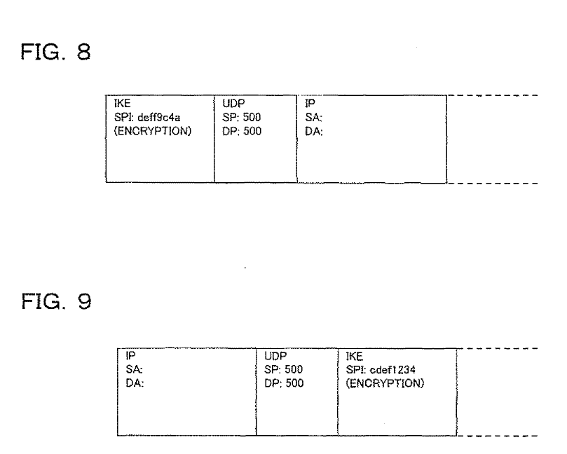

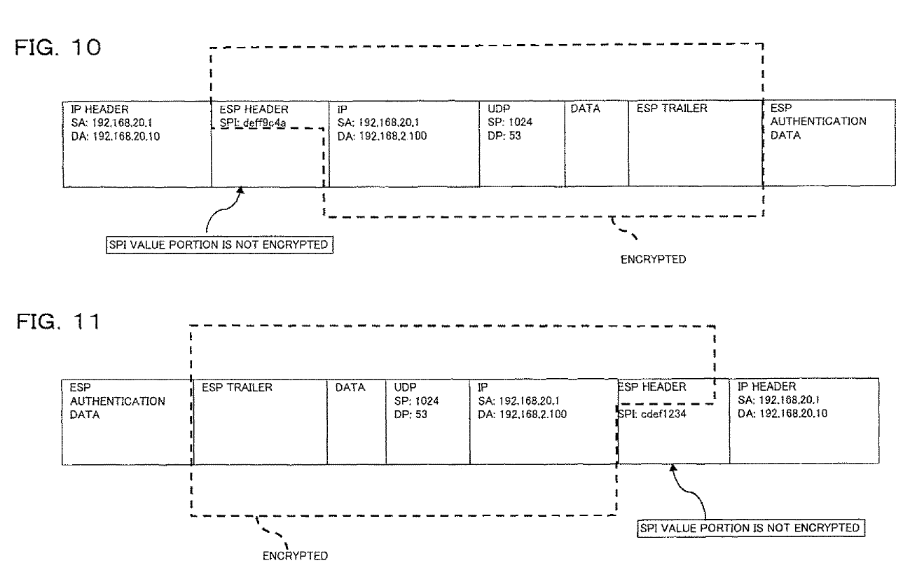

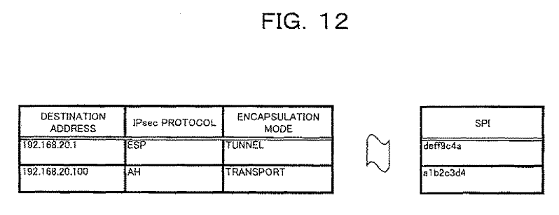

FIG. 8 is a diagram showing a part of a packet (an information packet for IPsec SA proposal and key generation) sent from the initiator 31 to the responder 32 in phase 2 of IPsec negotiation; FIG. 9 is a diagram showing a part of a packet (an information packet for IPsec proposal and key generation) sent from the responder 32 to the initiator 31 in phase 2 of IPsec negotiation; FIG. 10 is a diagram showing a construction example of a packet sent from the initiator 31 to the responder 32 after completion of IPsec negotiation; FIG. 11 is a diagram showing a construction example of a packet sent from the responder 32 to the initiator 31 after completion of IPsec negotiation; FIG. 12 is a diagram showing an example of the SAD of a responder 32 coupled to the router 10 according to one preferred embodiment of the present invention.

Here, the SPI value is an arbitrary 32-bit value used by each of the initiator 31 and the responder 32 for searching an SAD (Security Association Database; see FIG. 12) of its own when they decrypt an IPsec encrypted packet. The SPI value is generated by the initiator 31, and as shown in FIG. 8, it is stored in an “information packet for IPsec proposal and key creation” sent by the initiator 31 in the beginning of phase 2 of IPsec negotiation.

In addition, as shown in FIG. 9, the SPI value is stored also in an “information packet for IPsec SA proposal and key creation” sent by the responder 32 to the initiator 31 in the beginning of phase 2 of IPsec negotiation.

The responder 32 obtains the SPI value stored in the “information packet for IPsec SA proposal and key creation” (see FIG. 8) sent by the initiator 31. As shown in FIG. 10, when sending a packet in encryption communication after completion of negotiation, the responder 32 sends an encrypted packet with the SPI value being stored therein.

As shown in FIG. 12, the initiator 31 stores an SAD constructed by associating an SPI value with a destination address, an IPsec protocol, an encapsulation mode or the like, in a non-illustrated storage device such as a memory and a hard disc. Upon reception of an encrypted packet, the initiator 31 searches the SAD of its own using the SPI value and decrypts the encrypted packet.

On the other hand, in a case where the initiator 31 sends a packet, the initiator 31 obtains an SPI value from the “information packet for IPsec proposal and key creation” (see FIG. 9) sent from the responder 32 in the beginning of phase 2 of IPsec negotiation. As shown in FIG. 11, the initiator 31 sends the packet with the thus obtained SPI value stored therein.

The second distributing unit 23 refers to the second routing table 25 based on an SPI value of the packet obtained by the SPI value obtaining unit 24, and distributes the packet to the destination initiator 31.

Concretely, with respect to a packet sent from the responder 32 during normal communication, the second distributing unit 23 refers to the second routing table 25 based on the SPI value obtained by the SPI value obtaining unit 24 and obtains the address (source address) of the initiator 31 corresponding to the SPI value. The second distributing unit 23 then performs distribution in such a manner that the packet is sent to the initiator 31, and makes the LAN communication unit 11 send the packet to the address of the initiator 31 to which the packet was distributed.

That is, in the present router 10, an SPI value acts a role similar to a port number in the IP masquerade after completion of IPsec negotiation.

As shown in FIG. 10 and FIG. 11, since the portion of the SPI value in an encryption packet after completion of negotiation is not encrypted, it is possible for the router 10 to obtain the SPI values of encrypted packets sent from the responder 32 and to refer to the second routing table 25, thereby distributing the encrypted packets to each of the initiators 31a and 31b. Further, as to packets sent from the initiators 31a and 31b, only their source addresses are changed before sending of the packets to the responder 32.

Further, the second distributing unit 23 distributes a packet with reference to the third routing table 16 at the time IPsec is invalid.

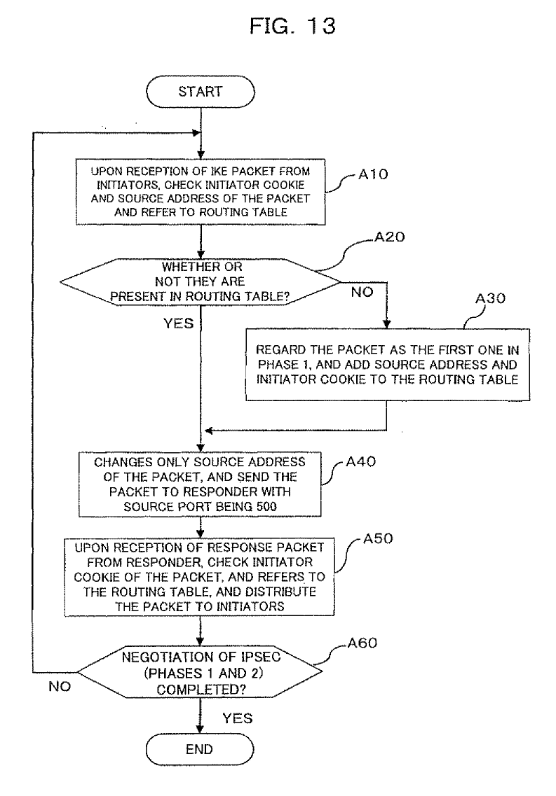

A description will be made herein below of processing performed by the router 10 with the above described construction during IPsec negotiation according to one preferred embodiment of the present invention, following the flowchart (step A10 through A60) shown in FIG. 13.

When the router 10 receives an IKE packet from the initiator 31, the initiator cookie obtaining unit 12 obtains the initiator cookie of the received packet. The first registering unit 13 refers to the first routing table 14 based on this initiator cookie (step A10) and the source address of the packet, and checks whether or not such initiator cookie and source address are registered (stored) in the first routing table 14 (step A20).

If these initiator cookie and source address are registered in the first routing table 14 (see YES rout of step A20), the first distributing unit 15 obtains the address (source address) of the initiator 31 corresponding to the initiator cookie from the first routing table 14, and changes the source address of the packet to be transferred to the source address obtained from the first routing table 14.

The restraining unit 18 restrains the IP masquerade function, and the port number setting unit 19 sets the source port of the packet to 500, and the first distributing unit 15 makes the WAN communication unit 17 send the packet to the responder 32 (step A40).

On the other hand, if these initiator cookie and source address are not registered in the first routing table 14 (see NO route of step A20), the first registering unit 13 regards the packet as the first packet (“ISAKMP SA proposal” packet) in phase 1 of IPsec negotiation, and adds (registers) these initiator cookie, pre-NAT (Network Address Translation) source address, post-NAT destination address, pre-NAT source port, post-NAT source port, pre-NAT destination port, and post-NAT destination port, in association with each other, to the first routing table 14 (step A30), and then the processing shifts to step A40.

Then, when receiving a response packet from the responder 32, the initiator cookie obtaining unit 12 obtains the initiator cookie of the received packet, and the first distributing unit 15 refers to the first routing table 14 based on the thus obtained initiator cookie, and distributes the packet to the destination initiator 31 (step A50).

The router 10 checks whether or not every process of phases 1 and 2 of IPsec negotiation is completed (step A60). If every process of phases 1 and 2 in IPsec negotiation is completed (see YES route of step A60), the router 10 ends the processing. Contrarily, if every process in phases 1 and 2 of IPsec negotiation is not completed (see NO route of step A60), the processing returns to step A10.

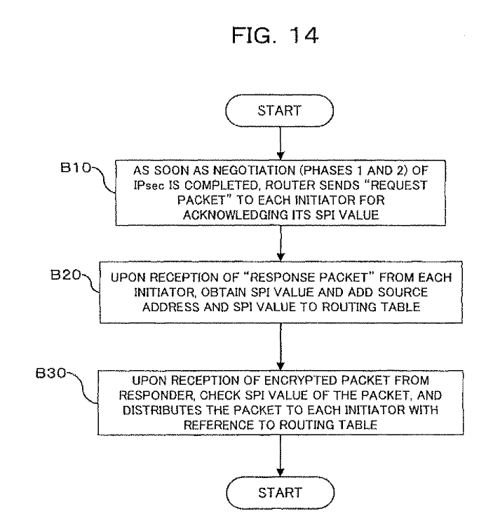

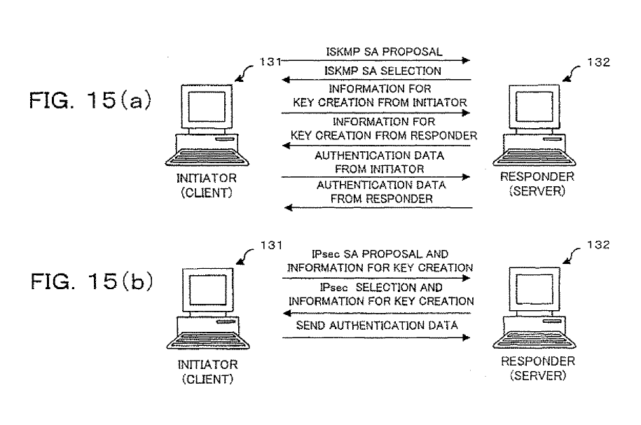

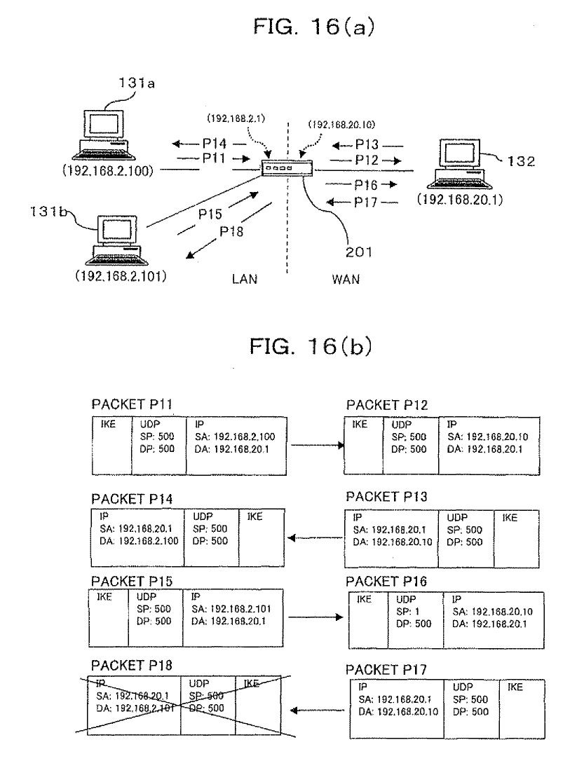

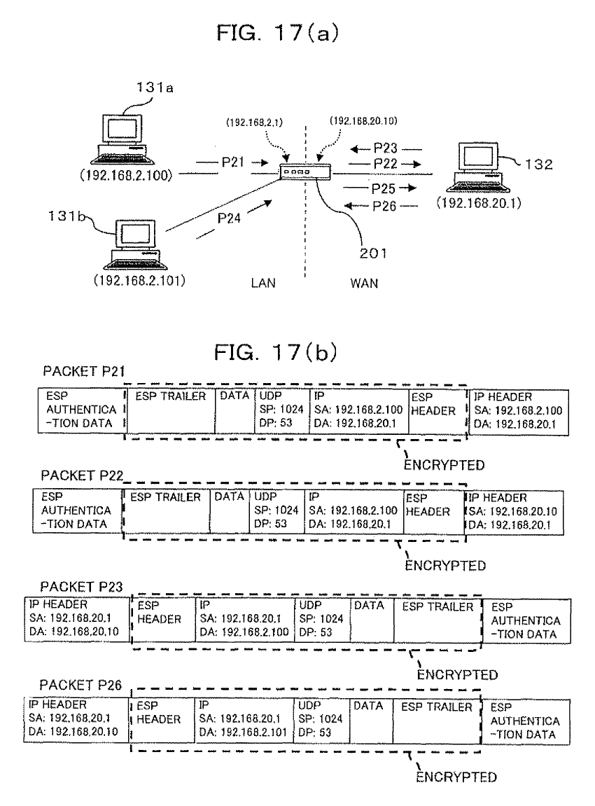

Subsequently, a description will be made hereinbelow of processing performed after completion of IPsec negotiation in the router 10 according to one preferred embodiment of the present invention, following the flowchart (step B10 through step B30) of FIG. 14.

After completion of IPsec negotiation (phases 1 and 2), the router 10 sends a request packet to each initiator 31 to acknowledge the SPI value of each initiator 31 (step B10). Upon reception of the request packet, each initiator 31 sends a response packet containing its SPI value to the router 10.

The router 10 receives the response packet sent from each initiator 31, and obtains the SPI value from the response packet. The second registering unit 22 registers (adds) a pre-NAT source address, a post-NAT source address, a pre-NAT destination address, a post-NAT destination address, and the SPI value, in association with each other, to the second routing table 25 (step B20).

Then, when the router 10 receives an encrypted packet from the responder 32, the SPI value obtaining unit 24 obtains the SPI value of the packet, and the second distributing unit 23 distributes the received packet to its destination initiator 31 with reference to the second routing table 25 based on the thus obtained SPI value (step B30).

In this manner, with the router 10 according to one preferred embodiment of the present invention, it is possible to perform IPsec negotiation between more than one initiator 31 (LAN end PC) and the responder 32 (WAN end PC), and also possible to perform encryption communication, distributing IPsec encrypted packets correctly.

That is, during IPsec negotiation, the router 10 registers the initiator cookie of the initiator 31 obtained by the first initiator cookie obtaining unit 12, the address of the initiator 31, and the address of the responder 32, in association with each other, as the first routing table 14. Upon reception of a packet, the first distributing unit 15 distributes the packet to its destination initiator 31 with reference to the first routing table 14 based on the initiator cookie of the packet obtained by the first initiator cookie obtaining unit 12, thereby making it possible to distribute the packet to its destination initiator 31 with high reliability during IPsec negotiation, so that IPsec negotiation can be performed.

Further, during IPsec negotiation, the restraining unit 18 restrains the IP masquerade function in the present router 10, thereby restraining the source port value and the destination port value from being changed into arbitrary values, and the port number setting unit 19 changes the source ports of packets for negotiation sent from the initiators 31a and 31b into 500, following the IKE standard, thereby making it possible to perform IPsec negotiation with high reliability.

Then, after completion of IPsec negotiation, the router 10 sends request packets to the initiators 31 and receives the SPI values sent from the initiators 31 as response packets, and registers these SPI values, the addresses of the initiators 31, and the address of the responder 32, in association with each other, as a second routing table 25, and distributes the packets to the destination initiators 31 with reference to the second routing table 25 based on the SPI values obtained by the SPI value obtaining unit 24, thereby making it possible to distribute IPsec encrypted packets with high reliability and high accuracy even after completion of IPsec negotiation.

Further, the present invention should by no means be limited to the above-illustrated embodiment, and various changes or modifications may be suggested without departing from the gist of the invention.

For example, in the above described embodiment, although the initiator cookie obtained by the first initiator cookie obtaining unit 12, the address of the initiator 31, and the address of the responder 32 are registered in association with each other, the present invention should by no means be limited to this. For example, information other than the above mentioned information items can be registered in association with the initiator cookie and the address of the initiator 31. Further, in a case where only one responder 32 is present, only an initiator cookie and the address of its initiator 31 can be registered.

Further, in the above described embodiment, a request packet has a TCP/IP header and a data portion, and the data portion stores a command (SPI_value) requesting transmission of an SPI value, but the present invention should by no means be limited to this. Another command than SPI_value can be used for requesting transmission of an SPI value, and information other than such a command can be contained in a request packet.

Furthermore, in the above described embodiment, the first routing table 14 and the second routing table 25 are provided as different tables, but the present invention should by no means be limited to this. These first routing table 14 and the second routing table 25 can be combined to be provided as a single table, so that there can be provided one routing table having functions of both of the first routing table 14 and the second routing table 25.

Here, the present invention can be summarized as follows.

The relay apparatus of the present invention has the IP (Internet Protocol) masquerade function and performs transceiving of packets between a responder and more than one initiator. The relay apparatus features in that it includes: a first initiator cookie obtaining unit which obtains an initiator cookie generated by an initiator, from the first packet (“ISAKMP SA proposal” packet) in phase 1 of IKE (Internet Key Exchange) sent from the initiator during IPsec (IP Security) negotiation; a first registering unit which registers the initiator cookies obtained by the first initiator cookie obtaining unit, the addresses of the initiators, and the address of the responder, in association with each other, as a first routing table; a second initiator obtaining unit for obtaining the initiator cookies of the packets sent from the responder; and a first distributing unit which refers to the first routing table based on the initiator cookies obtained by the first initiator cookie obtaining unit, and distributes the packets to their destination initiators 31.

In this instance, the relay apparatus of the present invention may include: a restraining unit which restrains the IP masquerade function during the specification is establishing communication; and a port number setting unit which sets the source ports of negotiation packets sent from the initiators, following the IKE standard, and sends the packets, setting of whose source ports was performed by the port number setting unit, to the responder.

Then, the relay apparatus may include: a request packet sending unit which sends to the initiators request packets which request the initiators of notifications of the SPI (Security Parameter Index) values thereof that were used during the negotiation, after completion of the negotiation; a response packet receiving unit which receives the SPI values sent from the initiators as response packets thereof in response to the request packets sent from the initiators; a second registering unit which registers the SPI values received by the response packet receiving unit, the addresses of the initiators, and the address of the responder, in association with each other, as second routing table; an SPI value obtaining unit which obtains the SPI values from the packets sent from the responder; and a second distribution unit which distributes the packets to their destination initiators, with reference to the second routing table based on the SPI value obtained by the SPI value obtaining unit.

Further, the relay method according to the present invention is for performing transceiving of packets between a responder and more than one initiator using the IP (Internet Protocol) masquerade function. The relay method features in that it may include: the first initiator cookie obtaining step for obtaining an initiator cookie generated by an initiator from the first packet (“ISAKMP SA proposal” packet) in phase 1 of IKE (Internet Key Exchange) during IPsec negotiation; the first registering step for registering the initiator cookie obtained in the first initiator cookie obtaining step, the address of the initiator, and the address of the responder, in association with each other, as first routing table; the second initiator cookie obtaining step for obtaining the initiator cookie of the packet sent from the initiator; and the first distributing step for distributing the packet to its destination initiator, which is a destination thereof, with reference to the first routing table based on the initiator cookie obtained in the second initiator cookie obtaining step.

In this instance, the relay method may include: the restraining step for restraining the IP masquerade function during the above described IPsec negotiation; and the port number setting step for setting the source ports of negotiation packets sent from the initiator, following the IKE standard. In the port number setting step, the packets, in which setting of the source ports has been performed in the port number setting step, can be sent to the responder.

Further, the relay method may include: the request packet sending step for sending request packets requesting the initiators of notifications of their SPI (Security Parameter Index) values which were used during the IPsec negotiation after completion of the IPsec negotiation; the response packet receiving step for receiving the SPI values sent from the initiators as response packets thereof in response to the request packets sent in the request packet sending step; the second registering step for registering the SPI values received in the response packet receiving step, the addresses of the initiators, and the address of the responder, in association with each other, as a second routing table; the SPI value obtaining step for obtaining the SPI values from the packets sent from the responder; and the second distributing step for distributing the packets to the destination initiators, which are destinations thereof, with reference to the second routing table based on the SPI values obtained in the SPI value obtaining step.

Furthermore, the relay program according to the present invention is a relay program which instructs a computer to perform transceiving of packets between a responder and more than one initiator using the IP (Internet Protocol) masquerade function. The relay program features in that it instructs a computer to execute the following steps: the first initiator cookie obtaining step for obtaining an initiator cookie generated by the initiator from the first packet (“ISAKMP SA proposal” packet) in phase 1 of IKE (Internet Key Exchange) during IPsec negotiation; the first registering step for registering the initiator cookie obtained in the first initiator cookie obtaining step, the address of the initiator, and the address of the responder, in association with each other, as first routing table; the second initiator cookie obtaining step for obtaining the initiator cookie of a packet sent from the responder; and the first distributing step for distributing the packet to the destination initiator, which is a destination thereof, with reference to the first routing table based on the initiator cookie obtained in the second initiator cookie obtaining step.

In this instance, the relay program may instruct the computer to execute the following steps: the restraining step for restraining the IP masquerade function during the above described IPsec negotiation; and the port number setting step for setting the source ports of the negotiation packets sent from the initiators, following the IKE standard. The relay program may also instruct the computer to send the packets, in which setting of source ports thereof has been performed in the port number setting step, to the responder.

Further, the relay program may instruct the computer to execute the following steps: the request packet sending step for sending request packets requesting the initiators of notifications of the SPI (Security Parameter Index) values which were used during the IPsec negotiation after completion of the IPsec negotiation; the response packet receiving step for receiving the SPI values sent from the initiators as response packets thereof in response to the request packets sent in the request packet sending step; the second registering step for registering the SPI values received in the response packet receiving step, the addresses of the initiators, and the address of the responder, in association with each other, as a second routing table; the SPI value obtaining step for obtaining the SPI values from the packets sent from the responder; and the second distributing step for distributing the packets to the destination initiators, which are destinations thereof, with reference to the second routing table based on the SPI value obtained in the SPI values obtaining step.

Further, the computer-readable recording medium according to the present invention records the above described relay program therein.

Furthermore, the information processing apparatus according to the present invention includes the IP (Internet Protocol) masquerade function, and transceives packets with the responder by way of the relay apparatus. The information processing apparatus features in that it includes: a request packet receiving unit which receives a request packet sent from the relay apparatus, after completion of IPsec negotiation; and a response packet sending unit which sends the SPI (Security Parameter Index) value which was used during the IPsec negotiation, as a response packet thereof, to the relay apparatus when the request packet receiving unit receives the request packet.

In this instance, a disclosure of the embodiment of the present invention enables the ordinarily skilled in the art to implement and manufacture the present invention.

### INDUSTRIAL APPLICABILITY

The present invention is applicable to various types of packet transmission equipment which performs IPsec packet transmission between a responder and more than one initiator with use of the IP masquerade function as well as a router.

What is claimed is:

1. A relay apparatus which is capable of transceiving encrypted transmission data between a first apparatus and a second apparatus, said relay apparatus comprising:
a first security information obtaining unit which obtains security information from transmission data sent from the first apparatus at the time of specification establishing communication performed between the first apparatus and the second apparatus, which specification establishing communication is previously performed to encryption communication;
a first registering unit which registers the security information obtained by said first security information obtaining unit and the address of the first apparatus, as first routing information, in association with each other;
a second security information obtaining unit which obtains security information from the transmission data sent from the second apparatus; and
a first distributing unit which distributes the transmission data to the first apparatus, which is a destination thereof, with reference to the first routing information based on the security information obtained by the second security information obtaining unit.

2. The relay apparatus as set forth in claim 1, wherein said relay apparatus has the IP (Internet Protocol) masquerade function and further comprises:
a restraining unit which restrains the IP masquerade function at the time of the specification establishing communication; and
a port number setting unit which is capable of arbitrarily setting a source port of transmission data sent from the first apparatus at the time of the specification establishing communication,
said relay apparatus sending the transmission data, to which the source port is set by said port number setting unit, to the second apparatus.

3. The relay apparatus as set forth in claim 1, further comprising:
a request signal sending unit which sends a request signal requesting the first apparatus of a notification of an identification value that was used at the time of the specification establishing communication after completion of the specification establishing communication;
a response signal receiving unit which receives the identification value sent from the first apparatus as a response signal thereof in response to the request signal sent from said request signal sending unit;
a second registering unit which registers the identification value received by said response signal receiving unit and the address of the first apparatus, as second routing information, in association with each other;
an identification value obtaining unit which obtains the identification value from the transmission data sent from said second apparatus; and
a second distribution unit which distributes the transmission data to the first apparatus, which is a destination thereof, with reference to the second routing information based on the identification value obtained by said identification value obtaining unit.

4. A relay method which is capable of transceiving encrypted transmission data between a first apparatus and a second apparatus, said method comprising:
(a) obtaining security information from transmission data sent from the first apparatus at the time of specification establishing communication performed between the first apparatus and the second apparatus, which specification establishing communication is previously performed to encryption communication;
(b) registering the security information obtained in the item (a) and the address of the first apparatus, as first routing information, in association with each other;
(c) obtaining security information from the transmission data sent from the second apparatus; and
(d) distributing the transmission data to the first apparatus, which is a destination thereof, with reference to the first routing information based on the security information obtained in the item (c).

5. The relay method as set forth in claim 4, further comprising:
(e) restraining the IP (Internet Protocol) masquerade function at the time of the specification establishing communication; and
(f) setting arbitrarily a source port of transmission data sent from the first apparatus at the time of the specification establishing communication,
wherein in the item (d), the transmission data, to which the source port is set in the item (f), is sent to the second apparatus.

6. The relay method as set forth in claim 4, further comprising:
(g) sending a request signal requesting the first apparatus of a notification of an identification value which is used at the time of the specification establishing communication after completion of the specification establishing communication;
(h) receiving the identification value sent from the first apparatus as a response signal thereof in response to the request signal sent in the item (g);
(i) registering the identification value received in the item (h) and the address of the first apparatus, as second routing information, in association with each other;
(j) obtaining the identification value from the transmission data sent from the second apparatus; and
(k) distributing the transmission data to the first apparatus, which is a destination thereof, with reference to the second routing information based on the identification value obtained in the item (j).

7. A computer-readable recording medium which records a relay program for a computer to perform transceiving encrypted transmission data between a first apparatus and a second apparatus wherein the relay program instructs a computer to execute the following:
(a) obtaining security information from transmission data sent from the first apparatus at the time of specification establishing communication between the first apparatus and the second apparatus, which specification establishing communication is previously performed to encryption communication;
(b) registering the security information obtained in the item (a) and the address of the first apparatus, as first routing information, in association with each other;
(c) obtaining security information from the transmission data sent from the second apparatus; and
(d) distributing the transmission data to the first apparatus, which is a destination thereof, with reference to the first routing information based on the security information obtained in the item (c).

8. The computer-readable recording medium which records a relay program as set forth in claim 7,
wherein the relay program instructs a computer to execute the following:
(e) restraining an IP (Internet Protocol) masquerade function at the time of the specification establishing communication; and
(f) setting arbitrarily a source port for transmission data sent from the first apparatus at the time of the specification establishing communication, and
wherein in the item (d), the transmission data, to which the source port is set in the item (f), is sent to the second apparatus.

9. The computer-readable recording medium which records a relay program as set forth in claim 7, wherein the program instructs a computer to execute the following:
(g) sending a request signal requesting the first apparatus of a notification of an identification value which is used at the time of the specification establishing communication after completion of the specification establishing communication;
(h) receiving the identification value sent from the first apparatus as a response signal thereof in response to the request signal sent in the item (g);
(i) registering the identification value received in the item (h) and the address of the first apparatus, as second routing information, in association with each other;
(j) obtaining the identification value from the transmission data sent from the second apparatus; and
(k) distributing the transmission data to the first apparatus, which is a destination thereof, with reference to the second routing information based on the identification value obtained in the item (j).

10. An information processing apparatus which tranceives transmission data with another information processing apparatus by way of a relay apparatus, said apparatus comprising:
a request signal receiving unit which receives a request signal transmitted from the relay apparatus, after completion of specification establishing communication that is performed with said another information processing apparatus previously to the specification establishment communication; and
a response signal sending unit which sends an identification value which is used at the time of the specification communication, as a response signal thereof, to the relay apparatus when the request signal receiving unit receives the request signal.
